(19) United States
(12) Patent Application Publication
(10) Pub. No.: US 2025/0149556 A1
(43) Pub. Date: May 8, 2025

(54) ELECTRODE ACTIVE MATERIAL, ELECTRODE MIXTURE, AND BATTERY

(71) Applicant: TOYOTA JIDOSHA KABUSHIKI KAISHA, Aichi-ken (JP)

(72) Inventor: Shohei KAWASHIMA, Susono-shi (JP)

(21) Appl. No.: 18/923,674

(22) Filed: Oct. 23, 2024

(30) Foreign Application Priority Data
Nov. 2, 2023 (JP) 2023-188821

(51) Int. Cl. H01M 4/36; H01M 4/505; H01M 4/525; H01M 4/62; H01M 10/42

(52) U.S. Cl. CPC H01M 4/366; H01M 4/505; H01M 4/525; H01M 4/628; H01M 10/4235

(57) ABSTRACT

Disclosed is a technique that can improve cycle characteristics of a battery when the battery is configured using an electrode active material having an O2-type structure. The electrode active material of the present disclosure comprises O2-type Li-containing oxide and lithium hydroxide, and is characterized in that an O1s spectrum of the electrode active material acquired by XPS satisfies 0.20≤S1/(S1+S2)≤0.73 (S1: area of peak derived from lithium hydroxide at 531.4 eV, and S2: area of peak derived from the O2-type Li-containing oxide at 529.4 eV).

### FIELD

The present application discloses an electrode active material, an electrode mixture, and a battery.

### BACKGROUND

Active materials for batteries having an O2-type structure (O: Octahedral) are known. As disclosed in PTL 1, an active material having an O2-type structure can be obtained by ion exchange of at least a portion of Na in a Na-containing oxide having a P2-type structure with Li.

### CITATION LIST

### Patent Literature

[PTL 1] Japanese Unexamined Patent Publication (Kokai) No. 2010-092824

### SUMMARY

### Technical Problem

Batteries that use an electrode active material having an O2-type structure have room for improvement in terms of cycle characteristics.

### Solution to Problem

The present application, as a means for achieving the above object, discloses the following plurality of aspects.

### <Aspect 1>

An electrode active material, comprising
O2-type Li-containing oxide and
lithium hydroxide, wherein
an O1s spectrum of the electrode active material acquired by XPS satisfies a relationship (1) below:

$$0.2 \leq S 1 / ( S 1 + S 2 ) \leq 0 \text{.73} \qquad ( 1 )$$

S1: area of peak derived from lithium hydroxide at 531.4 eV;
S2: area of peak derived from O2-type Li-containing oxide at 529.4 eV.

### <Aspect 2>

The electrode active material according to Aspect 1, wherein
the O1s spectrum satisfies a relationship (1A) below:

$$0.39 \leq S 1 / ( S 1 + S 2 ) \leq 0.68 . \qquad ( 1 A )$$

### <Aspect 3>

An electrode mixture, comprising the electrode active material according to Aspect 1 or 2.

### <Aspect 4>

A battery, comprising a positive electrode active material layer, an electrolyte layer, and a negative electrode active material layer, wherein
the positive electrode active material layer comprises the electrode active material according to Aspect 1 or 2.

### Effects

When a battery is configured using the electrode active material of the present disclosure, cycle characteristics of the battery is easily improved.

### BRIEF DESCRIPTION OF DRAWINGS

FIG. 1 schematically shows one example of a configuration of a cross-section of the electrode active material.

FIG. 2 shows one example of the flow of a manufacturing method of the electrode active material.

FIG. 3 schematically shows one example of a configuration of the battery.

FIG. 4 is an XPS-O1s spectrum of each of the electrode active materials according to Examples 2 and 4 and Comparative Examples 1 and 3.

FIG. 5 shows a relationship between S1/(S1+S2) and capacity retention rate.

### DESCRIPTION OF EMBODIMENTS

Hereinafter, one embodiment of each of the electrode active material, the electrode mixture, and the battery of the present disclosure will be described. However, the electrode active material, the electrode mixture, and the battery of the present disclosure are not limited to the embodiments described below.

### 1. ELECTRODE ACTIVE MATERIAL

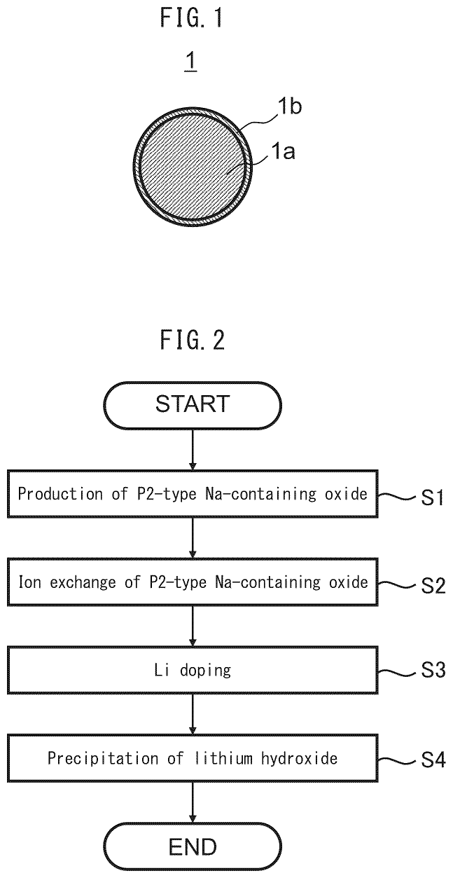

As shown in FIG. 1, the electrode active material 1 according to one embodiment comprises O2-type Li-containing oxide 1a and lithium hydroxide 1b. An O1s spectrum of the electrode active material 1 acquired by XPS satisfies a relationship (1) below:

$$0.2 \leq S 1 / ( S 1 + S 2 ) \leq 0 \text{.73} \qquad ( 1 )$$

S1: area of peak derived from lithium hydroxide at 531.4 eV;
S2: area of peak derived from O2-type Li-containing oxide at 529.4 eV.

### 1.1 O2-Type Li-Containing Oxide

### 1.1.1 Crystal Structure

The O2-type Li-containing oxide 1a has an O2-type structure as a crystal structure. The O2-type Li-containing oxide 1a may have a crystal structure other than an O2-type structure, in addition to having an O2-type structure. Examples of crystal structures other than an O2-type structure include a T #2-type structure (belonging to space group Cmca) and an O6-type structure (belonging to space group R-3m, with a c-axis length of 2.5 nm or more and 3.5 nm or less, typically 2.9 nm or more and 3.0 nm or less, and differing from an O3-type structure belonging to the same space group R-3m), formed when Li is deintercalated from an O2-type structure. The O2-type Li-containing oxide 1a according to one embodiment may have an O2-type structure as the main phase or may have a crystal structure (for example, O6-type structure) other than an O2-type structure as the main phase. The O2-type Li-containing oxide 1a according to one embodiment can have, depending on the charge and discharge states thereof, a crystal structure for the main phase that changes.

### 1.1.2 Chemical Composition

The O2-type Li-containing oxide 1a, for example, may at least comprise, as constituent elements, at least one element among Mn, Ni, and Co; Li; and O. In the O2-type Li-containing oxide 1a, particularly when at least Li, Mn, one or both of Ni and Co, and O are included as constituent elements, especially when at least Li, Mn, Ni, Co, and O are included as constituent elements, higher performance is easily obtained. The O2-type Li-containing oxide 1a may have a chemical composition represented by LiₐNa_{b}Mnₓ₋ₚNi_{y-q}Co_{z-r}M_{p+q+r}O₂ (where 0<a≤1.00; 0≤b≤0.20; x+y+z=1; and 0≤p+q+r<0.17, and the element M is at least one selected from B, Mg, Al, K, Ca, Ti, V, Cr, Fe, Cu, Zn, Ga, Ge, Sr, Y, Zr, Nb, Mo, and W). When the O2-type Li-containing oxide 1a has such a chemical composition, an O2-type structure is easily maintained. In the chemical composition above, a is greater than 0 and may be 0.10 or greater, 0.20 or greater, 0.30 or greater, 0.40 or greater, 0.50 or greater, or 0.60 or greater, and is 1.00 or less and may be 0.90 or less, 0.80 or less, or 0.70 or less. In the chemical composition above, b is 0 or greater and may be 0.01 or greater, 0.02 or greater, or 0.03 or greater, and is 0.20 or less and may be 0.15 or less, or 0.10 or less. In addition, x is 0 or greater and may be 0.10 or greater, 0.20 or greater, 0.30 or greater, 0.40 or greater, or 0.50 or greater, and is 1.00 or less and may be 0.90 or less, 0.80 or less, 0.70 or less, 0.60 or less, or 0.50 or less. Further, y is 0 or greater and may be 0.10 or greater or 0.20 or greater, and is 1.00 or less and may be 0.90 or less, 0.80 or less, 0.70 or less, 0.60 or less, 0.50 or less, 0.40 or less, 0.30 or less, or 0.20 or less. Moreover, z is 0 or greater and may be 0.10 or greater, 0.20 or greater, or 0.30 or greater, and is 1.00 or less and may be 0.90 or less, 0.80 or less, 0.70 or less, 0.60 or less, 0.50 or less, 0.40 or less, or 0.30 or less. The element M has a small contribution towards charging and discharging. In this regard, in the above chemical composition, by having p+q+r less than 0.17, high charge and discharge capacities are easily ensured. p+q+r may be 0.16 or less, 0.15 or less, 0.14 or less, 0.13 or less, 0.12 or less, 0.11 or less, or 0.10 or less. By including the element M, an O2-type structure is easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but may be variable without being limited to exactly 2.0.

### 1.2 Lithium Hydroxide

The electrode active material 1 comprises an O2-type Li-containing oxide 1a and lithium hydroxide 1b. As shown in FIG. 1, the electrode active material 1 may comprise an O2-type Li-containing oxide 1a and lithium hydroxide 1b covering at least a portion of the surface of the O2-type Li-containing oxide 1a. The amount of lithium hydroxide 1b contained in the electrode active material 1 needs only to satisfy the relationship (1) described below.

### 1.3 O1s Spectrum of Electrode Active Material Acquired by XPS

The amount of lithium hydroxide 1b in the electrode active material 1 can be measured by X-ray photoelectron spectroscopy (XPS). XPS is a method of analyzing constituent elements of a sample surface and electron states thereof by irradiating the sample surface with X-ray and measuring the emitted photoelectron energy. A spectrum acquired by XPS shows a pattern unique to a substance and a peak area proportional to the substance amount, and thus qualitative and quantitative analysis of the substance is possible. When the O1s spectrum of the electrode active material 1 acquired by XPS satisfies the relationship (1) above, it can be said that lithium hydroxide 1b is suitably precipitated on the surface of the O2-type Li-containing oxide 1a. In the case of lithium hydroxide 1b suitably precipitated on the surface of the O2-type Li-containing oxide 1a, when the electrode active material 1 is used to configure a battery and the battery is charged to a high electric potential region, contact between the O2-type Li-containing oxide 1a and an electrolyte is prevented by lithium hydroxide 1b while Li conduction paths between the active material and the electrolyte are secured, and deterioration and decomposition of the electrolyte during charging are easily suppressed. Specifically, by using the electrode active material 1 to configure a battery, a battery having excellent cycle characteristics is obtained.

Particularly, when the O1s spectrum of the electrode active material 1 acquired by XPS satisfies a relationship (1A) below, the cycle characteristic improvement effect is more remarkable.

$$0.39 \leq S 1 / ( S 1 + S 2 ) \leq 0.68 \qquad ( 1 A )$$

The O1s spectrum above can be configured where the peak derived from lithium hydroxide at 531.4 eV and the peak derived from the O2-type Li-containing oxide at 529.4 eV overlap. Therefore, when specifying the above peak areas S1 and S2, waveform separation by curve fitting (typically, fitting based on the non-linear least squares method) is carried out. This allows the peaks at positions of 531.4 eV and 529.4 eV as binding energies to be separated and the area of each peak to be specified. Waveform separation can be carried out, for example, by using the software “MultiPak” developed by ULVAC-PHI, Inc. Note that the “peak at position of 531.4 eV” and the “peak at position of 529.4 eV” allow for deviation (+0.1 eV) in the peak top positions that can occur due to measurement conditions. 1.4 Others

The electrode active material 1, as described below, can be obtained by substituting Na in a Na-containing oxide having a P2-type structure with Li to obtain an O2-type Li-containing oxide 1a and then precipitating lithium hydroxide 1b. The P2-type structure has a hexagonal crystal system and a large Na ion diffusion coefficient, and crystals are easily grown in a specific direction. Particularly, when a transition metal element constituting the P2-type structure includes at least one of Mn, Ni, and Co, tabular crystals are grown easily in a specific direction. Therefore, a Na-containing oxide having a P2-type structure generally forms into tabular particles having a large aspect ratio, wherein crystal growth direction is biased in a specific direction. The electrode active material 1 may be obtained based on such tabular Na-containing oxide particles, or may be obtained based on spherical Na-containing oxide particles. Specifically, the shape of the electrode active material 1 may be of a tabular particle, or may be of a spherical particle. When the electrode active material 1 is a spherical particle, reaction resistance is decreased due to the decrease in crystallite size, and diffusion resistance inside the particle is easily decreased. Further, when applied to a battery, it is considered that the degree of curvature is decreased by spheroidization, and lithium-ion conduction resistance is decreased, whereby, for example, rate characteristics are improved and reversible capacity is easily increased. A “spherical particle” in the present application means a particle having a circularity of 0.80 or greater. The circularity of the spherical particle may be 0.81 or greater, 0.82 or greater, 0.83 or greater, 0.84 or greater, 0.85 or greater, 0.86 or greater, 0.87 or greater, 0.88 or greater, 0.89 or greater, or 0.90 or greater. The circularity of a particle is defined as 4TS/L, where S is the orthographic area of the particle and L is the circumference of an orthographic image of the particle. The circularity of a particle can be determined by observing the exterior of the particle with a scanning electron microscope (SEM), a transmission electron microscope (TEM), or an optical microscope.

The electrode active material 1, for example, may be solid particles, may be hollow particles, or may be particles having voids. The size of the particles of the electrode active material 1 is not particularly limited. However, a smaller size is considered advantageous. For example, the average particle size (D50) of the particles of the electrode active material 1 may be 0.1 μm or more and 10 μm or less, 1.0 μm or more and 8.0 μm or less, or 2.0 μm or more and 6.0 μm or less. Note that the average particle size (D50) is the 50% cumulative particle size (D50, median diameter) in a volume-based particle size distribution determined by a laser diffraction/scattering method.

### 2. MANUFACTURING METHOD OF ELECTRODE ACTIVE MATERIAL

The electrode active material 1 can be manufactured by, for example, the following method. Specifically, as shown in FIG. 2, the manufacturing method for the electrode active material 1 according to one embodiment may comprise
S1: obtaining a Na-containing transition metal oxide having a P2-type structure,
S2: subjecting at least a portion of Na in the Na-containing oxide to ion exchange with Li to obtain a Li-containing oxide having an O2-type structure,
S3: further doping the Li-containing oxide with Li in a separate step from the ion exchange, and
S4: precipitating lithium hydroxide to a surface of the Li-containing oxide after Li doping.

### 2.1 S1

In S1, a Na-containing transition metal oxide having a P2-type structure can be manufactured via, for example,
S11: obtaining a precursor (for example, a precursor comprising at least one element among Mn, Ni, and Co),
S12: covering a surface of the precursor with a Na source to obtain a composite, and
S13: firing the composite.
   The S13 may comprise
S13-1: subjecting the composite to a pre-firing at a temperature of 300° C. or higher and lower than 700° C. for 2 h or more and 10 h or less,
S13-2: following the pre-firing, subjecting the composite to a main firing at a temperature of 700° C. or higher and 1100° C. or lower for 30 min or more and 48 h or less, and
S13-3: following the main firing, rapidly cooling the composite from a temperature T1 of 200° C. or higher to a temperature T₂ of 100° C. or lower.

### 2.1.1 Production of Precursor

The precursor may comprise at least Mn and one or both of Ni and Co, or may comprise at least Mn, Ni, and Co. The precursor may be a salt comprising at least one element among Mn, Ni, and Co. The precursor, for example, may be at least one of a carbonate, a sulfate, a nitrate, and an acetate. Alternatively, the precursor may be a compound other than a salt. The precursor, for example, may be a hydroxide. The precursor may be a hydrate. The precursor may be a combination of a plurality of compounds. The precursor may be of various shapes. For example, the precursor may be particulate, and may be spherical particles as described below. The particle size of the particles consisting of the precursor is not particularly limited.

In S11, a precipitate as the precursor above may be obtained by a coprecipitation method using an ion source that can form a precipitation with a transition metal ion in an aqueous solution and a transition metal compound comprising at least one element among Mn, Ni, and Co. As a result, spherical particles as the precursor are easily obtained. An “ion source that can form a precipitation with a transition metal ion in an aqueous solution”, for example, may be at least one selected from sodium salts such as sodium carbonate and sodium nitrate, sodium hydroxide, and sodium oxide. The transition metal compound may be a salt or hydroxide described above comprising at least one element among Mn, Ni, and Co. Specifically, in S11, the ion source and the transition metal compound may each be formed into a solution, and the solutions may then be dropped and mixed to obtain a precipitate as the precursor. In this case, for example, water is used as a solvent. In this case, various sodium compounds may be used as a base, and ammonia aqueous solution may be added to adjust basicity. In the case of a coprecipitation method, the precipitate as the precursor is obtained, for example, by preparing an aqueous solution of a transition metal compound and an aqueous solution of sodium carbonate and dropping each to mix the aqueous solutions. Alternatively, it is possible to obtain the precursor by a sol-gel method. Particularly, according to the coprecipitation method, spherical particles as the precursor are easily obtained.

In S11, the precursor may comprise an element M. The element M is at least one selected from B, Mg, Al, K, Ca, Ti, V, Cr, Cu, Zn, Ga, Ge, Sr, Y, Zr, Nb, Mo, and W. These elements M, for example, have a function of stabilizing a P2-type structure and an O2-type structure. The method of obtaining a precursor comprising an element M is not particularly limited. When a precursor is obtained by a coprecipitation method in S11, for example, an aqueous solution of a transition metal compound comprising at least one of Mn, Ni, and Co, an aqueous solution of sodium carbonate, and an aqueous solution of a compound of the element M are prepared, the aqueous solutions are each added dropwise and mixed, whereby a precursor comprising at least one element among Mn, Ni, and Co and the element M is obtained. Alternatively, in the manufacturing method of the present disclosure, the element M is not added in S11, and the element M may be doped when carrying out a Na-doping firing in S2 and S3 described below.

### 2.1.2 Production of Composite

In S12, the surface of the precursor obtained via S11 is covered with a Na source to obtain a composite. The Na source may be a salt comprising Na, such as a carbonate or a nitrate, or may be a compound other than a salt, such as sodium oxide or sodium hydroxide. In S12, the amount of the Na source for covering the surface of the precursor may be determined by taking into account the amount of Na lost during subsequent firing. In S12, the coverage of the Na source relative to the surface of the precursor is not particularly limited. In S12, the method of covering the surface of the above precursor with the Na source is not particularly limited. For example, the precursor and the Na source may be mixed by a mortar or a mixing apparatus, or a solution comprising the Na source may be brought into contact with the precursor using a rolling fluidized coating method or a spray drying method and then dried.

In S12, the precursor may be covered with a Na source and an M source. For example, in S12, the precursor obtained via S11, a Na source, and an M source comprising at least one element selected from B, Mg, Al, K, Ca, Ti, V, Cr, Cu, Zn, Ga, Ge, Sr, Y, Zr, Nb, Mo, and W may be mixed to obtain a composite. The M source, for example, may be a salt comprising an element M, such as a carbonate or a sulfate, or may be a compound other than a salt, such as an oxide or a hydroxide. The amount of the M source relative to the precursor may be determined in accordance with the chemical composition of the Na-containing oxide after firing.

### 2.1.3 Firing of Composite

In S13, the composite obtained via S12 is fired to obtain a Na-containing oxide having a P2-type structure. S13 may comprise the above S13-1, S13-2, and S13-3. By adjusting the conditions of S13-1, S13-2, and S13-3, crystallinity and shape (tabular particle or spherical particle) of P2-type Na-containing obtained via S13 can be adjusted.

In S13-1, the composite is subjected to a pre-firing at a temperature of 300° C. or higher and lower than 700° C. for 2 h or more and 10 h or less. In S13-1, the pre-firing may be carried out after optionally molding the above composite. The pre-firing is carried out at a temperature lower than that of main firing. When the pre-firing in S13-1 is insufficient, it is possible that generation of a P2 phase in the ultimately obtained Na-containing oxide is insufficient. In S13-1, by setting the pre-firing temperature to 300° C. or higher and lower than 700° C. and the pre-firing time to 2 h or more and 10 h or less, the composite can be subjected to a sufficient pre-firing, heat uniformity is improved, and the Na-containing oxide obtained via S13-2 and S13-3 described below is likely a suitable one. The pre-firing temperature may be 400° C. or higher and lower than 700° C., 450° C. or higher and lower than 700° C., 500° C. or higher and lower than 700° C., 550° C. or higher and lower than 700° C., or 550° C. or higher and 650° C. or lower. The pre-firing time may be 2 h or more and 8 h or less, 3 h or more and 8 h or less, 4 h or more and 8 h or less, 5 h or more and 8 h or less, or 5 h or more and 7 h or less. The pre-firing atmosphere is not particularly limited, and for example, may be an oxygen-containing atmosphere.

In S13-2, following the above pre-firing, the composite is subjected to a main firing at a temperature of 700° C. or higher and 1100° C. or lower for 30 min or more and 48 h or less. In S13-2, the main firing temperature of the composite may be 800° C. or higher and 1000° C. or lower. When the main firing temperature is too low, a P2 phase is not generated, and when the main firing temperature is too high, an O3 phase, not a P2 phase, is easily generated. The heating conditions from the pre-firing temperature to the main firing temperature is not particularly limited. In S13-2, the shape of the Na-containing oxide can be controlled by the main firing time. When the main firing time is too short, generation of the P2 phase is insufficient. When the main firing time is too long, the P2 phase grows excessively and the particles easily become tabular and coarse.

In S13-3, following the above main firing, the composite undergoes rapid cooling (cooled at a cooling rate of 20° C./min or higher) from a temperature T1 of 200° C. or higher to a temperature T2 of 100° C. or lower. The above pre-firing and main firing are carried out in, for example, a heating furnace. In the step S13-3, for example, the composite is subjected to a main firing in a heating furnace and then cooled to an arbitrary temperature T₁ of 200° C. or higher in the heating furnace, and after reaching the temperature T₁, the fired product is removed from the heating furnace and undergoes rapid cooling outside the furnace to an arbitrary temperature T₂ of 100° C. or lower. The temperature T₁ is an arbitrary temperature of 200° C. or higher, and may be an arbitrary temperature of 250° C. or higher. The temperature T₂ is an arbitrary temperature of 100° C. or lower, and may be an arbitrary temperature of 50° C. or lower or may be the cooling end temperature. In the predetermined temperature region from the temperature T₁ until reaching the temperature T₂, moisture easily infiltrates between layers of a P2-type structure by atomic vibrations or molecular motion. When cooling the composite (Na-containing oxide having a P2-type structure) after main firing, by shortening the time in the temperature region where such moisture easily infiltrates (i.e., rapid cooling), it is considered that the infiltration amount of moisture between layers of the P2-type structure is decreased. In this regard, in the step S13-3, when cooling the composite after the main firing, by leaving the composite particles to cool from an arbitrary temperature T₁ of 200° C. or higher until reaching an arbitrary temperature T₂ of 100° C. or lower in, for example, a dry atmosphere outside the furnace, the cooling rate from the temperature T₁ to the temperature T₂ is rapid (for example, 20° C./min or higher), moisture does not easily infiltrate between layers of the P2-type structure, and collapse of the P2-type structure can be inhibited. As a result, Na can efficiently undergo ion exchange with Li in S2.

A Na-containing oxide having a P2-type structure and having a predetermined chemical composition can be manufactured by S13. The Na-containing oxide at least comprises, as constituent elements, at least one transition metal element among Mn, Ni, and Co; Na; and O. Particularly, when the constituent elements at least include Na, Mn, at least one of Ni and Co, and O, especially when the constituent elements include at least Na, Mn, Ni, Co, and O, performance of the positive electrode active material is easily increased. The Na-containing oxide may have a chemical composition represented by Na_{c}Mnₓ₋ₚNi_{y-q}Co_{z-r}M_{p+q+r}O₂, where 0<c<1.00, x+y+Z=1, and 0≤p+q+r<0.17. In addition, M is at least one element selected from B, Mg, Al, K, Ca, Ti, V, Cr, Fe, Cu, Zn, Ga, Ge, Sr, Y, Zr, Nb, Mo, and W. When the Na-containing oxide has such a chemical composition, a P2-type structure is more easily maintained. In the above chemical composition, c is greater than 0 and may be 0.10 or greater, 0.20 or greater, 0.30 or greater, 0.40 or greater, 0.50 or greater, or 0.60 or greater, and is less than 1.00 and may be 0.90 or less, 0.80 or less, or 0.70 or less. x is 0 or greater and may be 0.10 or greater, 0.20 or greater, 0.30 or greater, 0.40 or greater, or 0.50 or greater, and is 1.00 or less and may be 0.90 or less, 0.80 or less, 0.70 or less, 0.60 or less, or 0.50 or less. y is 0 or greater and may be 0.10 or greater or 0.20 or greater, and is 1.00 or less and may be 0.90 or less, 0.80 or less, 0.70 or less, 0.60 or less, 0.50 or less, 0.40 or less, 0.30 or less, or 0.20 or less. z is 0 or greater and may be 0.10 or greater, 0.20 or greater, or 0.30 or greater, and is 1.00 or less and may be 0.90 or less, 0.80 or less, 0.70 or less, 0.60 or less, 0.50 or less, 0.40 or less, or 0.30 or less. The element M has a small contribution towards charging and discharging. In this regard, in the above chemical composition, by having p+q+r less than 0.17, high charge and discharge capacities are easily ensured. p+q+r may be 0.16 or less, 0.15 or less, 0.14 or less, 0.13 or less, 0.12 or less, 0.11 or less, or 0.10 or less. By including the element M, P2-type and O2-type structures are easily stabilized. In the above chemical composition, p+q+r is 0 or greater and may be 0.01 or greater, 0.02 or greater, 0.03 or greater, 0.04 or greater, 0.05 or greater, 0.06 or greater, 0.07 or greater, 0.08 or greater, 0.09 or greater, or 0.10 or greater. The composition of O is approximately 2, but may be variable without being limited to exactly 2.0.

### 2.2 S2

In S2, by subjecting at least a portion of Na in the Na-containing oxide obtained via S1 to ion exchange with Li, a Li-containing oxide having an O2-type structure is obtained. Ion exchange includes, for example, a method using an aqueous solution comprising a lithium halide and a method using a mixture (for example, a molten salt) of a lithium halide and an additional lithium salt. From the viewpoint that a P2-type structure is easily broken by water infiltration and the viewpoint of crystallinity, of the above two methods, a method using a molten salt is preferable. Specifically, the above Na-containing oxide having a P2-type structure and the molten salt are mixed and heated to a temperature of the melting point of the molten salt or higher, whereby at least a portion of Na in the Na-containing oxide can be substituted with Li by ion exchange. The lithium halide constituting the molten salt is preferably at least one of lithium chloride, lithium bromide, and lithium iodide. An additional lithium salt constituting the molten salt is preferably lithium nitrate. By using a molten salt, the melting point is lowered compared to when the lithium halide and the additional lithium salt are used independently, and ion exchange at a lower temperature is possible. The temperature of the ion exchange, for example, may be the melting point of the above molten salt or higher and 600° C. or lower, 500° C. or lower, 400° C. or lower, or 300° C. or lower. When the temperature of the ion exchange is too high, an O3-type structure, which is a stable phase, not an O2-type structure, is easily generated. From the viewpoint of shortening the time required for the ion exchange, the temperature of the ion exchange is preferably as high as possible.

### 2.3 S3

In S3, the Li-containing oxide obtained via the above S2 can be further doped with Li in a separate step from the ion exchange, thereby increasing the molar ratio of Li in the Li-containing oxide (the above a). In S3, for example, the Li-containing oxide may be further doped with Li in a separate step from the above ion exchange without applying a driving force by voltage. For example, by bringing a Li doping source into contact with the Li-containing oxide, the Li-containing oxide may be doped with Li. Specifically, in S3, it is preferable that the Li-containing oxide be further doped with Li by bringing a reducing solution comprising Li ions into contact with the Li-containing oxide. A “reducing solution” means a solution having reducing properties, and for example, may be a solution comprising an electrophile. The reducing solution, for example, may be obtained by dissolving an electrophile and a Li source in a solvent. Various organic solvents capable of dissolving an electrophile and a Li source can be adopted as the solvent. The solvent, for example, is preferably an ether-based solvent such as tetrahydrofuran or dimethoxyethane. Various substances that dissolve in the above solvent can be adopted as the electrophile. The electrophile is preferably an aromatic organic compound such as diphenyl. For the Li source, various substances that generate Li ions when dissolved in the above solvent can be adopted. The Li source may be metallic lithium or may be a Li compound. The concentrations of the electrophile and the Li ions contained in the reducing solution need only to be appropriately determined in accordance with the target doping amount. In S3, for example, the Li-containing oxide can be doped with Li simply by bringing the Li-containing oxide into contact with the reducing solution described above. The contact form between the reducing solution and the Li-containing oxide is not particularly limited. For example, a Li-containing transition metal oxide may be immersed in a reducing solution, or the reducing solution may be sprayed onto the Li-containing transition metal oxide. The temperature during contact is not particularly limited, and heating may or may not be carried out. The Li-containing oxide may be immersed in the reducing solution and then stirred. The time of the Li-containing oxide being brought into contact with the reducing solution is not particularly limited, and needs only to be appropriately determined in accordance with the target doping amount.

### 2.4 S4

In S4, for example, by exposing the Li-containing oxide doped with Li via the above S3 to an arbitrary dew point environment, lithium hydroxide is precipitated on the surface of the Li-containing oxide. Specifically, a portion of Li contained in the Li-containing oxide is reacted with moisture to precipitate lithium hydroxide on the surface of the Li-containing oxide, whereby the above electrode active material 1 is obtained. By adjusting the dew point environment and the exposure time, the amount of lithium hydroxide precipitated on the surface of the Li-containing oxide can be adjusted. In S4, the dew point environment and the exposure time needs only to be adjusted so that the electrode active material 1 obtained after exposure satisfies the above relationship (1).

### 3. ELECTRODE MIXTURE

The electrode mixture according to one embodiment comprises the above electrode active material 1 of the present disclosure. A component other than the electrode active material 1 contained in the electrode mixture is not particularly limited, and can be appropriately determined in accordance with the target performance. The electrode mixture according to one embodiment may comprise the above electrode active material 1 of the present disclosure and at least one of an electrolyte, a conductive aid, and a binder. The electrode mixture according to one embodiment may optionally comprise other additives. The content of each of the active material, electrolyte, conductive aid, and binder in the electrode mixture needs only to be appropriately determined in accordance with the target battery performance. For example, when the entire solid content contained in the electrode mixture is 100% by mass, the content of the electrode active material may be 40% by mass or greater and less than 100% by mass.

### 3.1 Active Material

The active material contained in the electrode mixture may consist only of the above electrode active material 1 of the present disclosure, or may comprise the electrode active material 1 and another active material (additional active material). From the viewpoint of further enhancing the effect of the technique of the present disclosure, the proportion of the additional active material to the entire active material contained in the electrode mixture may be a small amount. For example, when the entirety of the active material contained in the electrode mixture is 100% by mass, the content of the above electrode active material 1 of the present disclosure may be 50% by mass or greater and 100% by mass or less, 60% by mass or greater and 100% by mass or less, 70% by mass or greater and 100% by mass or less, 80% by mass or greater and 100% by mass or less, 90% by mass or greater and 100% by mass or less, 95% by mass or greater and 100% by mass or less, or 99% by mass or greater and 100% by mass or less. For an additional active material that can be contained in the electrode mixture, any known active material can be adopted as the additional active material.

### 3.2 Electrolyte

The electrode mixture can comprise the above electrode active material 1 and an electrolyte. The electrolyte that can be contained in the electrode mixture may be a solid electrolyte, may be a liquid electrolyte, or may be a combination thereof. The solid electrolyte needs only to be any known solid electrolyte for batteries. The solid electrolyte may be an inorganic solid electrolyte or an organic polymer electrolyte. Particularly, an inorganic solid electrolyte has excellent ion-conducting and heat resistance. Examples of inorganic solid electrolytes include oxide solid electrolytes, sulfide solid electrolytes, and inorganic solid electrolytes having ion-binding properties. Particularly, when the electrode mixture comprises a sulfide solid electrolyte as the solid electrolyte, higher performance is easily ensured. The sulfide solid electrolyte, for example, may comprise at least Li, S, and P as constituent elements. Alternatively, the electrode mixture may comprise a solid electrolyte having ion-binding properties as the solid electrolyte, for example, may comprise a solid electrolyte comprising, as constituent elements, at least Li, Y, and a halogen (at least one of Cl, Br, I, and F). The solid electrolyte may be amorphous, or may be crystalline. The solid electrolyte may be particulate. The average particle size (D50) of the solid electrolyte, for example, may be 10 nm or more and 10 μm or less. The solid electrolyte may be of one type used alone, or may be of two or more types used in combination. The liquid electrolyte (electrolyte solution) is a liquid comprising lithium ions as carrier ions. The electrolyte solution may be a water-based electrolyte solution or a non-water-based electrolyte solution. The composition of the electrolyte solution needs only to be the same as any known electrolyte solution for lithium-ion batteries. The electrolyte solution may be water or a non-water-based solvent dissolving a lithium salt. Examples of the non-water-based solvent include various carbonate-based solvents. Examples of the lithium salt include lithium amide and LiPF₆.

### 3.3 Conductive Aid

Examples of the conductive aid that can be contained in the electrode mixture include carbon materials such as vapor-grown carbon fiber (VGCF), acetylene black (AB), ketjen black (KB), carbon nanotube (CNT), and carbon nanofiber (CNF); and metal materials such as nickel, titanium, aluminum, and stainless steel. The conductive aid, for example, may be particulate or fibrous, and the size thereof is not particularly limited. The conductive aid may be of one type used alone, or may be of two or more types used in combination.

### 3.4 Binder

Examples of the binder that can be contained in the electrode mixture include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 3.5 Others

The electrode mixture may comprise various additives, in addition to the above components, for example, a dispersant or a lubricant.

### 4. BATTERY

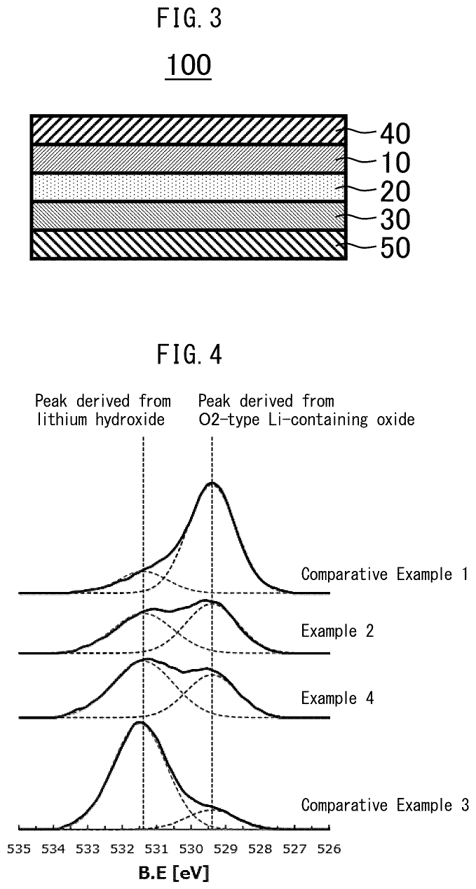

The electrode active material 1, for example, can be adopted as a positive electrode active material of a battery. As shown in FIG. 3, the battery 100 according to one embodiment comprises a positive electrode active material layer 10, an electrolyte layer 20, and a negative electrode active material layer 30. The positive electrode active material layer 10 comprises the above electrode active material 1 of the present disclosure.

### 4.1 Positive Electrode Active Material Layer

The positive electrode active material layer 10 comprises at least the above electrode active material 1 of the present disclosure, and may further optionally comprise an electrolyte, a conductive aid, and a binder. Further, the positive electrode active material layer 10 may additionally comprise various additives. In other words, the positive electrode active material layer 10 can be composed of the above electrode mixture. Particularly, when the positive electrode active material layer 10 comprises a liquid electrolyte (electrolyte solution), a greater effect can be expected. The shape of the positive electrode active material layer 10 is not particularly limited, and for example, may be a sheet-like positive electrode active material layer 10 having a substantially flat surface. The thickness of the positive electrode active material layer 10 is not particularly limited, and for example, may be 0.1 μm or more or 1 μm or more, and may be 2 mm or less or 1 mm or less.

### 4.2 Electrolyte Layer

The electrolyte layer 20 is arranged between the positive electrode active material layer 10 and the negative electrode active material layer 30. The electrolyte layer 20 comprises at least an electrolyte. The electrolyte layer 20 may comprise at least one of a solid electrolyte and a liquid electrolyte, and may further optionally comprise a binder. The contents of the electrolyte and the binder in the electrolyte layer 20 are not particularly limited. Alternatively, the electrolyte layer 20 may comprise a separator for retaining a liquid electrolyte and preventing contact between the positive electrode active material layer 10 and the negative electrode active material layer 30. The thickness of the electrolyte layer 20 is not particularly limited, and for example, may be 0.1 μm or more or 1 μm or more, and may be 2 mm or more or 1 mm or less.

The electrolyte contained in the electrolyte layer 20 needs only to be appropriately selected from among ones (solid electrolytes and/or liquid electrolytes) exemplified as an electrolyte that can be contained in the positive electrode active material layer 10 (electrode mixture) described above. Particularly, when the electrolyte layer 20 comprises a liquid electrolyte (electrolyte solution), a greater effect can be expected. The binder that can be contained in the electrolyte layer 20 needs only to be appropriately selected from among ones exemplified as a binder that can be contained in the positive electrode active material layer described above. The electrolyte and the binder may each be of one type used alone, or may be of two or more types used in combination. The separator needs only to be a commonly used separator in batteries. Examples thereof include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose nonwoven fabric, resin nonwoven fabric, or glass-fiber nonwoven fabric.

### 4.3 Negative Electrode Active Material Layer

The negative electrode active material layer 30 comprises at least a negative electrode active material. The negative electrode active material layer 30 may optionally comprise an electrolyte, a conductive aid, a binder, and various additives. The content of each component in the negative electrode active material layer 30 needs only to be appropriately determined in accordance with the target battery performance. For example, when the entire solid content of the negative electrode active material layer 30 is 100% by mass, the content of the negative electrode active material may be 40% by mass or greater, 50% by mass or greater, 60% by mass or greater, or 70% by mass or greater, and may be 100% by mass or less, less than 100% by mass, 95% by mass or less, or 90% by mass or less. Alternatively, when the entire negative electrode active material layer 30 is 100% by volume, the negative electrode active material and optionally the electrolyte, conductive aid, and binder in total may be contained at 85% by volume or greater, 90% by volume or greater, or 95% by volume or greater, and the remaining portion may be voids or additional components. The shape of the negative electrode active material layer 30 is not particularly limited, and for example, may be a sheet having a substantially flat surface. The thickness of the negative electrode active material layer 30 is not particularly limited, and for example, may be 0.1 μm or more, 1 μm or more, 10 μm or more, or 30 μm or more, and may be 2 mm or less, 1 mm or less, 500 μm or less, or 100 μm or less.

Any known negative electrode active material for batteries can be adopted as the negative electrode active material. Of known active materials, various materials having a low electric potential (charge and discharge potentials) for storing and releasing carrier ions compared to the above positive electrode active material can be adopted. For example, silicon-based active materials such as Si, Si alloys, and silicon oxides; carbon-based active materials such as graphite and hard carbon; various oxide-based active materials such as lithium titanate; and metallic lithium and lithium alloys can be adopted. Of these, when the negative electrode active material layer 30 comprises Si as a negative electrode active material, performance of the battery 100 is easily enhanced. The negative electrode active material may be of one type used alone, or may be of two or more types used in combination. The shape of the negative electrode active material needs only to be any general shapes of negative electrode active materials of batteries. For example, the negative electrode active material may be particulate. The negative electrode active material particles may be primary particles, or may be secondary particles of a plurality of agglomerated primary particles. The average particle size (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 30 may consist of a sheet of negative electrode active material.

The electrolyte that can be contained in the negative electrode active material layer 30, for example, includes the solid electrolytes and liquid electrolytes described above, and combinations thereof. Particularly, when the negative electrode active material layer 30 comprises a liquid electrolyte (electrolyte solution), a greater effect can be expected. The conductive aid that can be contained in the negative electrode active material layer 30, for example, needs only to be appropriately selected from among ones exemplified as a conductive aid that can be contained in the positive electrode active material layer 10 (electrode mixture) described above. The binder that can be contained in the negative electrode active material layer 30, for example, needs only to be appropriately selected from among one exemplified as a binder that can be contained in the positive electrode active material layer 10 (electrode mixture) described above. The electrolyte, the conductive aid, and the binder may each be of one type used alone, or may be of two or more types used in combination.

### 4.4 Positive Electrode Current Collector

As shown in FIG. 3, the battery 100 may be provided with a positive electrode current collector 40 in contact with the positive electrode active material layer 10. Any general positive electrode current collector for batteries can be adopted as the positive electrode current collector 40. The positive electrode current collector 40 may have at least one shape selected from foil-like, tabular, mesh-like, punched metal-like, and a foam. The positive electrode current collector 40 may be composed of a metal foil or a metal mesh. Particularly, a metal foil has excellent handleability. The positive electrode current collector 40 may consist of a plurality of foils. Examples of metals constituting the positive electrode current collector 40 include at least one selected from Cu, Ni, Cr, Au, Pt, Ag, Al, Fe, Ti, Zn, Co, V, Mg, Pg, Ge, In, Sn, Zr, and stainless steel. Particularly, from the viewpoint of ensuring oxidation resistance, the positive electrode current collector 40 may comprise Al. The positive electrode current collector 40 may have on the surface thereof some coating layer for the purpose of adjusting resistance. For example, the positive electrode current collector 40 may have a carbon coating layer. The positive electrode current collector 40 may be a metal foil or substrate plated or vapor-deposited with a metal described above. When the positive electrode current collector 40 consists of a plurality of metal foils, there may be some layer between the plurality of metal foils. The thickness of the positive electrode current collector 40 is not particularly limited, and for example, may be 0.1 μm or more or 1 μm or more, and may be 1 mm or less or 100 μm or less.

### 4.5 Negative Electrode Current Collector

As shown in FIG. 3, the battery 100 may be provided with a negative electrode current collector 50 in contact with the negative electrode active material layer 30. Any general negative electrode current collector for batteries can be adopted as the negative electrode current collector 50. The negative electrode current collector 50 may be foil-like, tabular, mesh-like, punched metal-like, or a foam. The negative electrode current collector 50 may be a metal foil or a metal mesh, and alternatively, may be a carbon sheet. Particularly, a metal foil has excellent handleability. The negative electrode current collector 50 may consist of a plurality of foils or sheets. Metals constituting the negative electrode current collector 50 include at least one selected from Cu, Ni, Cr, Au, Pt, Ag, Al, Fe, Ti, Zn, Co, V, Mg, Pb, Ge, In, Sn, Zr, and stainless steel. Particularly, from the viewpoint of ensuring reduction resistance and the viewpoint of making alloying with lithium difficult, the negative electrode current collector 50 may comprise at least one metal selected from Cu, Ni, and stainless steel. The negative electrode current collector 50 may have on the surface thereof some coating layer for the purpose of adjusting resistance. For example, the negative electrode current collector 50 may have a carbon coating layer. The negative electrode current collector 50 may be an aluminum foil having a carbon coating layer. The negative electrode current collector 50 may be a metal foil or a substrate plated or vapor-deposited with a metal described above. When the negative electrode current collector 50 consists of a plurality of metal foils, there may be some layer between the plurality of metal foils. The thickness of the negative electrode current collector 50 is not particularly limited, and for example, may be 0.1 μm or more or 1 μm or more, and may be 1 mm or less or 100 μm or less.

### 4.6 Additional Configurations

The battery 100, in addition to the above configurations, may be provided with any general configuration as a battery, for example, tabs or terminals. For the battery 100, the above configurations may each be housed inside an outer packaging. Any known outer packaging can be adopted as the outer packaging of the battery. In addition, a plurality of batteries 100 may be optionally connected electrically and optionally stacked to form a battery pack. In this case, the battery pack may be housed inside a known battery case. Examples of shapes of the battery 100 can include coin-type, laminate-type, cylindrical, and rectangular. The battery 100 may be a secondary battery.

The battery 100 can be manufactured by applying any known method, except that the above specific electrode active material 1 is used, and for example, can be manufactured as follows. However, the manufacturing method for the battery 100 is not limited to the following method. For example, each layer may be formed by dry molding.
(1) An electrode active material 1 constituting a positive electrode active material layer is dispersed in a solvent to obtain a positive electrode layer slurry. The solvent used in this case is not particularly limited, and water and various organic solvents can be used. The positive electrode layer slurry is then applied onto a surface of a positive electrode current collector using a doctor blade, followed by drying, whereby a positive electrode active material layer is formed on the surface of the positive electrode current collector to obtain a positive electrode.
(2) A negative electrode active material constituting a negative electrode active material layer is dispersed in a solvent to obtain a negative electrode layer slurry. The solvent used in this case is not particularly limited, and water and various organic solvents can be used. The negative electrode layer slurry is then applied onto a surface of a negative electrode current collector using a doctor blade, followed by drying, whereby a negative electrode active material layer is formed on the surface of the negative electrode current collector to obtain a negative electrode.
(3) Layers are laminated so that an electrolyte layer (solid electrolyte layer or separator) is interposed between the negative electrode and the positive electrode to obtain a laminated body comprising a negative electrode current collector, a negative electrode active material layer, an electrolyte layer, a positive electrode active material layer, and a positive electrode current collector in this order. Additional members such as terminals are attached to the laminated body as needed.
(4) The laminated body is housed in a battery case, and in the case of an electrolyte solution battery, the battery is filled with an electrolyte solution inside the battery case so that the laminated body is immersed in the electrolyte solution, and then the laminated body is sealed within the battery case, whereby a secondary battery is obtained. Note that in the case of an electrolyte solution battery, the electrolyte solution may be contained in the negative electrode active material layer, the separator, and the positive electrode active material layer in step (3) above.

### 5. VEHICLE

The battery of the present disclosure has excellent cycle characteristics by using the electrode active material 1. Such a battery, for example, can be suitably used in at least one type of vehicle selected from hybrid vehicle (HEV), plug-in hybrid vehicle (PHEV), and battery electric vehicle (BEV). Specifically, the technique of the present disclosure has an aspect of a vehicle comprising a battery, wherein the battery comprises a positive electrode active material layer, an electrolyte layer, and a negative electrode active material layer, wherein the positive electrode active material layer comprises the above electrode active material 1 of the present disclosure.

### EXAMPLES

From the foregoing, one embodiment of the electrode active material has been described. However, various modifications to the technique of the present disclosure other than the above embodiments are possible without departing from the spirit thereof. Hereinafter, the technique of the present disclosure will be further described in detail with reference to the Examples. However, the technique of the present disclosure is not limited to the following Examples.

### 1. Production of Electrode Active Material

### 1.1 Production of P2-Type Na-Containing Oxide

### 1.1.1 Production of Precursor

(1) MnSO₄·5H₂O, NiSO₄·6H₂O, and CoSO₄·7H₂O were weighed to a target compositional ratio (Mn:Ni:Co=5:2:3) and dissolved in distilled water to a concentration of 1.2 mol/L to obtain a first solution. In a separate container, Na₂CO₃ was dissolved in distilled water to a concentration of 1.2 mol/L to obtain a second solution.
(2) 1000 mL of pure water was loaded into a reactor (with baffles), and 500 mL of the first solution and 500 mL of the second solution were each added therein dropwise at a rate of about 4 mL/min.
(3) Upon completion of the dropwise addition, stirring was carried out a stirring rate of 150 rpm at room temperature for 1 h to obtain a product.
(4) The product was washed with pure water and subjected to solid-liquid separation with a centrifugal separator to recover a precipitate.
(5) The resulting precipitate was dried overnight at 120° C., crushed with a mortar, and then separated by airflow classification into coarse particles and fine particles. The fine particles were removed, and the coarse particles as precursor particles were obtained.

### 1.1.2 Production of Composite

(1) Na₂CO₃ and distilled water were weighed to 1150 g/L and then stirred until complete dissolution using a stirrer to produce a Na₂CO₃ aqueous solution.
(2) The above Na₂CO₃ aqueous solution and the above precursor particles were weighed and mixed so as to have a composition of Na_{0.8}Mn_{0.5}Ni_{0.2}Co_{0.3}O₂ after the firing described below to obtain a slurry.
(3) The above slurry was gas-flow dried by spray drying to obtain a composite. Specifically, using a spray drying apparatus DL410, under the conditions of a slurry feed rate of 30 mL/min, an inlet temperature of 200° C., a circulating air volume of 0.8 m³/min, and a spraying air pressure of 0.3 MPa, the above slurry was gas-flow dried to cover the surfaces of the precursor particles with Na₂CO₃ to obtain a composite.

### 1.1.3 Firing of Composite

The composite was loaded into an alumina crucible and fired under an ambient air atmosphere to obtain a Na-containing oxide having a P2-type structure. The firing conditions were as described in the following (1) to (5).
(1) An alumina crucible containing the above composite was set in a heating furnace in an ambient air atmosphere.
(2) Temperature inside the heating furnace was raised from room temperature (25° C.) to 600° C. in 115 min.
(3) Temperature inside the heating furnace was kept at 600° C. for 360 min to carry out pre-firing.
(4) After pre-firing, temperature inside the heating furnace was raised to 900° C. and kept at 900° C. for 60 min to carry out main firing.
(5) After main firing, temperature inside the heating furnace was lowered from the main firing temperature to 250° C., the alumina crucible was removed from the heating furnace at 250° C., and was left to cool outside the furnace in a dry atmosphere to reach 25° C. in 10 min.

The fired product after leaving to cool was crushed using a mortar under a dry atmosphere to obtain Na-containing oxide particles (P2-type particles) having a P2-type structure.

### 1.2 Ion Exchange

(1) LiNO₃ and LiCl were weighed to a molar ratio of 50:50 and mixed with the above P2-type particles at a molar ratio 10 times the minimum Li amount required for ion exchange to obtain a mixture.
(2) An alumina crucible was used to carry out ion exchange at 280° C. for 1 h under an ambient air atmosphere to obtain a product comprising a Li-containing oxide.
(3) Salt remaining in the product was washed away with pure water and the product was subjected to solid-liquid separation by vacuum filtration to obtain a precipitate.
(4) The resulting precipitate was dried overnight at 120° C. to obtain intermediate particles A. The intermediate particles A consisted of a Li-containing oxide represented by Li_{0.6}Mn_{0.5}Ni_{0.2}Co_{0.3}O₂. The crystal phase contained in the intermediate particles A was confirmed by XRD, where it was found that the intermediate particles A had an O2-type structure.

### 1.3 Li Doping

(1) Biphenyl was mixed and dissolved in tetrahydrofuran (THF) to 1 mol/L inside a glove box (Ar atmosphere) to obtain a biphenyl solution.
(2) Li foil at the same number of moles as the biphenyl was added in the biphenyl solution and stirred for 2 h to obtain a reducing solution comprising 1 mol/L of Li ions.
(3) The above intermediate particles A were added, immersed, and stirred in the obtained reducing solution for 24 h, wherein the addition amount of intermediate particles A was adjusted so that the ratio (Li/O₂) of the number of moles of dissolved Li ions relative to the number of moles of intermediate particles A was 0.4.
(4) The intermediate particles A after stirring were washed with THF and subjected to solid-liquid separation by vacuum filtration. The resulting precipitate was dried overnight at 120° C. to obtain intermediate particles B. The intermediate particles B consisted of a Li-containing oxide represented by Li_{0.98}Mn_{0.5}Ni_{0.2}Co_{0.3}O₂. The crystal phase contained in the intermediate particles B was confirmed by XRD, where it was found that the intermediate particles B had an O2-type structure.

### 1.4 Precipitation of Lithium Hydroxide

(1) The obtained intermediate particles B were sealed in a screw bottle under an Ar environment, and the bottle was moved out of the glove box.
(2) The intermediate particles B were exposed to an arbitrary dew point environment to cause lithium hydroxide to precipitate on the surfaces of the intermediate particles B to obtain an electrode active material for evaluation. By adjusting the dew point environment and the exposure time, a plurality of electrode active materials having different precipitation amounts of lithium hydroxide were obtained.
(3) The resulting plurality of electrode active materials were resealed in the screw bottle, transported inside a glove box, and stored.

### 2. EVALUATION OF PRECIPITATION AMOUNT OF LITHIUM HYDROXIDE IN ELECTRODE ACTIVE MATERIAL

For each of the above plurality of electrode active materials, an O1s spectrum was acquired by X-ray photoelectron spectroscopy (XPS). The measurement conditions of XPS were as follows. Note that, in the XPS measurements, the measurement point of 527.5 eV was set as the start point, the measurement point of 534 eV was set as the end point, and background processing was carried out by the Shirley method.

Measurement apparatus: scanning X-ray photoelectron spectrometer (u-XPS) Quantera II (manufactured by ULVAC-PHI, Inc.)
X-ray source used: mono-AlKa (1486.6 V)
Photoelectron take-off angle: 35°
X-ray beam diameter: about 100 μm
Neutralization gun conditions: 1.0 V, 20 μA

For each of the acquired O1s spectra, waveform separation by curve fitting (fitting based on the non-linear least squares method) was carried out, the peaks at positions of 531.4 eV and 529.4 eV as binding energies were separated, and peak areas S1 and S2 were each specified. Note that the waveform separation was executed by using the software “MultiPak” developed by ULVAC-PHI, Inc.

### 3. PRODUCTION OF COIN CELL

Each of the electrode active materials was used to produce a coin cell (CR2032). The production procedure of the coin cell was as follows.
(1) The above electrode active material, acetylene black (AB) as a conductive aid, and polyvinylidene fluoride (PVdF) as a binder were weighed so as to have a mass ratio of electrode active material:AB:PVdF=85:10:5 and dispersed and mixed in N-methyl-2-pyrrolidone to obtain a positive electrode mixture slurry. The positive electrode mixture slurry was applied onto an aluminum foil and vacuum-dried overnight at 120° C. to obtain a positive electrode that is a laminate of a positive electrode active material layer and a positive electrode current collector.
(2) LiPF₆ was dissolved in a mixed solvent obtained by mixing trifluoropropylene carbonate (TFPC) and trifluoroethyl methyl carbonate (TFEMC) at a ratio of TFPC:TFEMC=30 vol %: 70 vol % to a concentration of 1 M to obtain an electrolyte solution.
(3) A metallic lithium foil as a negative electrode was prepared.
(4) The positive electrode, the electrolyte solution, and the negative electrode were used to produce a coin cell (CR2032).

### 4. EVALUATION OF CHARGE-DISCHARGE CHARACTERISTICS OF COIN CELL

For each of the coin cells, 30 cycles of charging and discharging at a voltage range of 2.0 to 4.8 V and a rate of 0.1 C (1 C=240 mA/g) in an isothermal chamber maintained at 25° C. were repeated, and a ratio (capacity retention rate (%)) of discharge capacity after 30 cycles relative to initial discharge capacity was determined.

### 5. EVALUATION RESULTS

In Table 1 below, for each of the electrode active materials, the “area S1 of peak derived from lithium hydroxide at 531.4 eV”, “area S2 of peak derived from O2-type Li-containing oxide at 529.4 eV”, and “ratio (S1/(S1+S2)) of S1 relative to the total of S1 and S2” of the O1s spectrum acquired by XPS are shown. Further, in Table 1 below, the “initial discharge capacity”, “discharge capacity after 30 cycles”, and “capacity retention rate” of each of the coin cells are shown.

TABLE 1

| | | | | Initial | Capacity | Capacity |
|---|---|---|---|---|---|---|
| | | | | capacity | after 30 cyc | retention rate |
| | S1 | S2 | S1/(S1 + S2) | mAh/g | mAh/g | % |
| Comparative Example 1 | 89875 | 442451 | 0.17 | 235 | 217 | 92 |
| Example 1 | 102487 | 317490 | 0.24 | 235 | 218 | 93 |
| Example 2 | 149389 | 235892 | 0.39 | 235 | 224 | 95 |
| Example 3 | 202483 | 218179 | 0.48 | 236 | 228 | 97 |
| Example 4 | 293211 | 186993 | 0.61 | 234 | 227 | 97 |
| Example 5 | 332971 | 155782 | 0.68 | 235 | 222 | 94 |
| Comparative Example 2 | 410271 | 118432 | 0.78 | 233 | 210 | 90 |
| Comparative Example 3 | 483576 | 83021 | 0.85 | 232 | 207 | 89 |

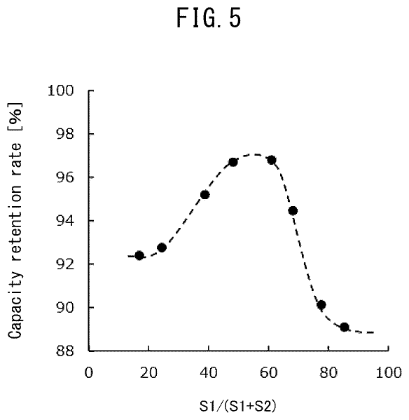

FIG. 4 shows XPS-O1s spectra of the electrode active materials according to Examples 2 and 4 and Comparative Examples 1 and 3. FIG. 5 shows a relationship between S1/(S1+S2) and capacity retention rate.

From the results shown in Table 1 and FIGS. 4 and 5, it was found that when S1/(S1+S2) in the XPS-O1s spectrum of an electrode active material was 0.20 or greater and 0.73 or less, the capacity retention rate of a battery was high. Particularly, when S1/(S1+S2) was 0.39 or greater and 0.68 or less, capacity retention rate was significantly improved. It is considered that by precipitating a suitable amount of lithium hydroxide to the surface of the electrode active material, contact between the active material and the electrolyte was prevented in the high electric potential region during charging, thereby suppressing decomposition of the electrolyte. When S1/(S1+S2) exceeded 0.70, the capacity retention rate of a battery was decreased. It is considered that lithium hydroxide was excessively precipitated on the surface of the electrode active material and Li conduction between the active material and the electrolyte was locally inhibited, thereby overworking the active material in the active material-electrolyte where Li conduction was not inhibited.

The electrolyte (LiPF₆) generally used in liquid-based batteries generates hydrogen fluoride due to a trace amount of moisture in a battery. It is considered that lithium hydroxide precipitated on the surface of an electrode active material reacts with hydrogen fluoride in a battery to form lithium fluoride. Specifically, in the coin cells above, it is considered that a lithium fluoride layer was formed on the surface of the electrode active material, which is considered to further improve electric potential stability.

### 6. CONCLUSION

From the above results, it can be said that by using an electrode active material satisfying the following (1) and (2) to configure a battery, cycle characteristics of the battery are improved.
(1) The electrode active material comprises an O2-type Li-containing oxide and lithium hydroxide.
(2) The O1s spectrum of the electrode active material acquired by XPS satisfies the relationship (1) below:

$$0.2 \leq S 1 / ( S 1 + S 2 ) \leq 0 \text{.73} \qquad ( 1 )$$

S1: area of peak derived from lithium hydroxide at 531.4 eV;
S2: area of peak derived from O2-type Li-containing oxide at 529.4 eV.

### REFERENCE SIGNS LIST

1 electrode active material
1a O2-type Li-containing oxide
1b lithium hydroxide
100 battery
10 positive electrode active material layer
20 electrolyte layer
30 negative electrode active material layer
40 positive electrode current collector
50 negative electrode current collector

1. An electrode active material, comprising
O2-type Li-containing oxide and
lithium hydroxide, wherein
an O1s spectrum of the electrode active material acquired by XPS satisfies a relationship (1) below:
$$0.2 \leq S 1 / ( S 1 + S 2 ) \leq 0 \text{.73} \qquad ( 1 )$$
S1: peak area derived from lithium hydroxide at 531.4 eV;
S2: peak area derived from O2-type Li-containing oxide at 529.4 eV.

2. The electrode active material according to claim 1, wherein
the O1s spectrum satisfies a relationship (1A) below:
$$0.39 \leq S 1 / ( S 1 + S 2 ) \leq 0.68 . \qquad ( 1 A )$$

3. An electrode mixture, comprising the electrode active material according to claim 1.

4. A battery, comprising a positive electrode active material layer, an electrolyte layer, and a negative electrode active material layer, wherein
the positive electrode active material layer comprises the electrode active material according to claim 1.
